(19) United States
(12) Patent Application Publication
(10) Pub. No.: US 2006/0144100 A1
(43) Pub. Date: Jul. 6, 2006

(54) SLIKLOC security system

(76) Inventor: Verne E. Thomsen, Ames, NE (US)

Correspondence Address: Verne E. Thomsen, 1681 Co Rd 16, Ames, NE, 68621, US

(21) Appl. No.: 11/029,089

(22) Filed: Jan. 4, 2005

(51) Int. Cl. E05B 65/00

(52) U.S. Cl. 70/2

(57) ABSTRACT

The SLIKLOC Security System Permanent Locking Hasp has the highest level of anti-theft and anti-tampering design that virtually eliminates opening with a thief's tools of the trade—hacksaws, bolt cutters, large hammers, and pry bars. Most marine and railroad intermodal containers are unsecured or have limited security. Adding the SLIKLOC Security System to these modes of transportation would limit theft and decrease the chance of terrorists using these modes of transportation to damage our homeland.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

It has come to the attention of the inventor that large theft losses are being suffered by the railroad industry on the intermodal containers. Attempts of temporary locks have been marginally successful. A permanent hasp and security system is needed. The same hasp is designed to accommodate cargo vans and refrigerated vans for the trucking industry. This has been encouraged and reviewed by an executive of the Union Pacific Railroad.

In addition, it is designed to be used as protection in our Homeland Security as the same containers are used in overseas shipments.

In summary, it is to be used for theft protection on ships, trains, and trucks and for Homeland Security on ships, trains, and trucks.

### BRIEF SUMMARY OF THE INVENTION

The SLIKLOC Security System is a permanent locking system developed for the intermodal railroad containers, intermodal marine containers, and truck trailer cargo vans and refrigerated vans.

The system is designed to be locked with a hydraulically removed locking pin, which is to be removed with a hydraulic removal tool. It can also be locked with the push type lock, which would be unlocked with a pagoda key, or the push type lock, which would be unlocked with a barrel key. Each is available from ABA Lock Co.

Each system can be used with the same hasp. The hydraulically removed pins are installed and removed without the push type locks installed. When the hydraulically removable pin is absent, the push type locks can be installed in either the top or bottom of the permanent hasp or both the top and bottom of the hasp. The locks are fixed in place with a 10/32 allen screw.

### BRIEF DESCRIPTION OF THE SEVERAL VIEWS OF THE DRAWING

FIG. 1: SLIKLOC Assembly SL0001 and SL0002 Left and Right hand permanent locking hasp for vertical rear hinged doors on Semi-trucks, Intermodal railroad containers, and Intermodal marine containers and SL0003 Backing plate for inside of doors.

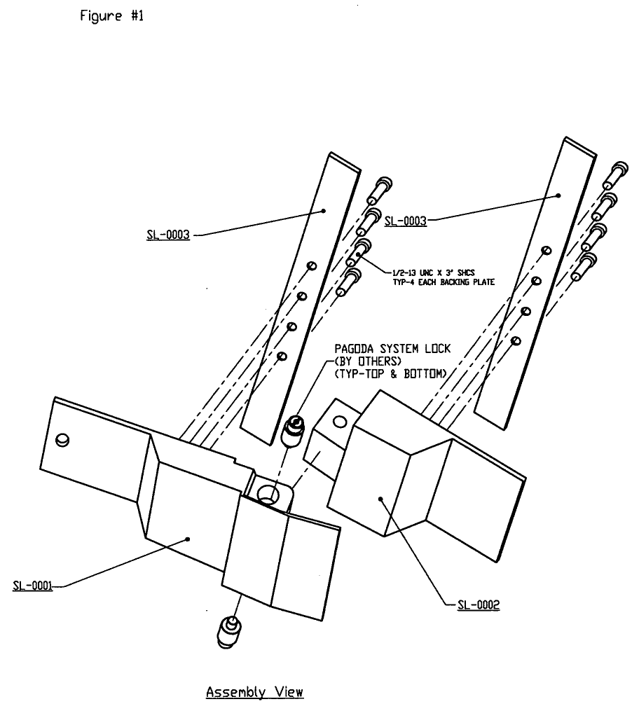

FIG. 2: SLIKLOC Security System permanent locking hasp for vertical rear hinged doors on semi truck trailers, intermodal railroad containers and intermodal marine containers. Drawing shows the hasp for the right door (last door to close). A. Top view. B. Front view. Hasp is fastened to the door with four-½ inch SAE bolts with a backing plate inside the door.

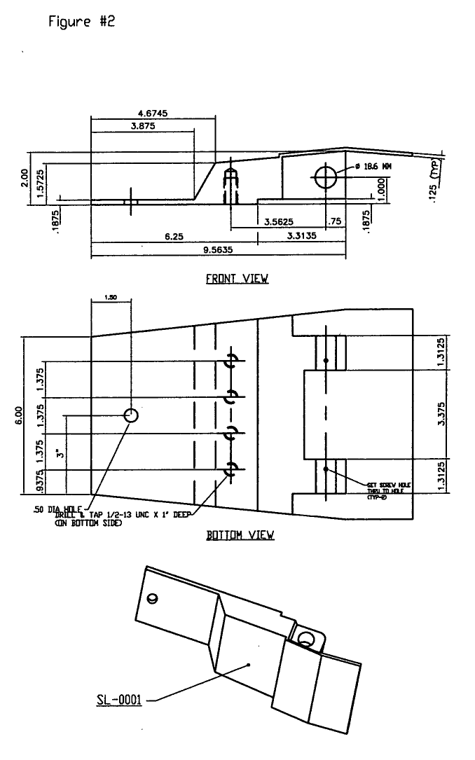

FIG. 3: SLIKLOC Security System permanent locking hasp for vertical rear hinged doors on semi-truck trailers, intermodal railroad containers and intermodal marine containers. Drawing shows the hasp for the left door (first door to close). A. Top view. B. Front view. Hasp is fastened to the door using four-½ inch SAE bolts with a backing plate inside the door.

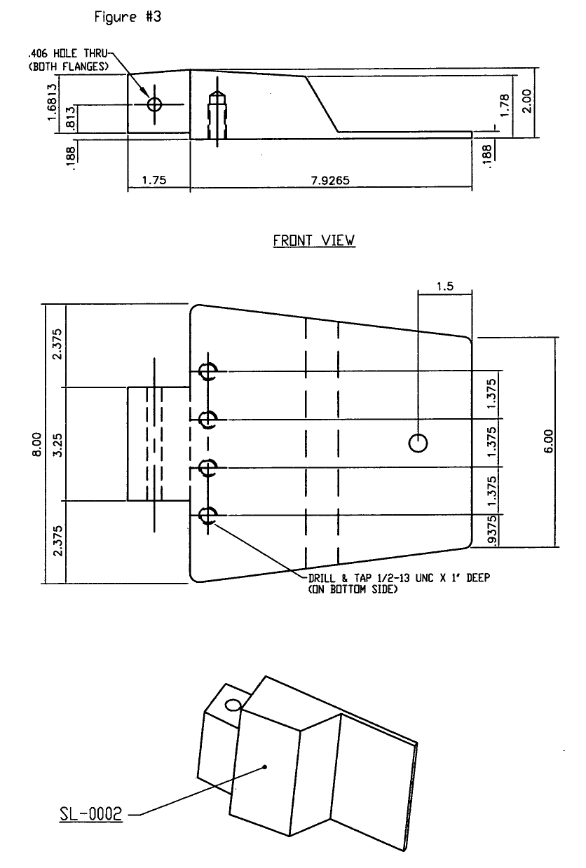

FIG. 4: SLIKLOC SL0003 Backing plate. Two backing plates are used to secure the left and right (SL0001 and SL0002) hasps to the vertical doors (placed on the inside of the doors and bolted with ½ inch grade 5 cap screws) of the semi-trailer cargo or refrigerated vans or intermodal railroad container or intermodal marine container.

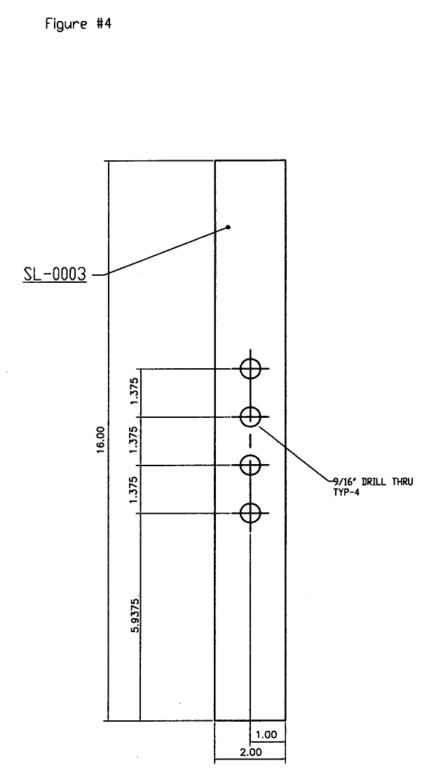

FIG. 5: SLIKLOC SL0004 Installation Tool. A guide to drill holes in both the left and right hand doors on a semi-trailer cargo or refrigerated vans or intermodal railroad container or intermodal marine container.

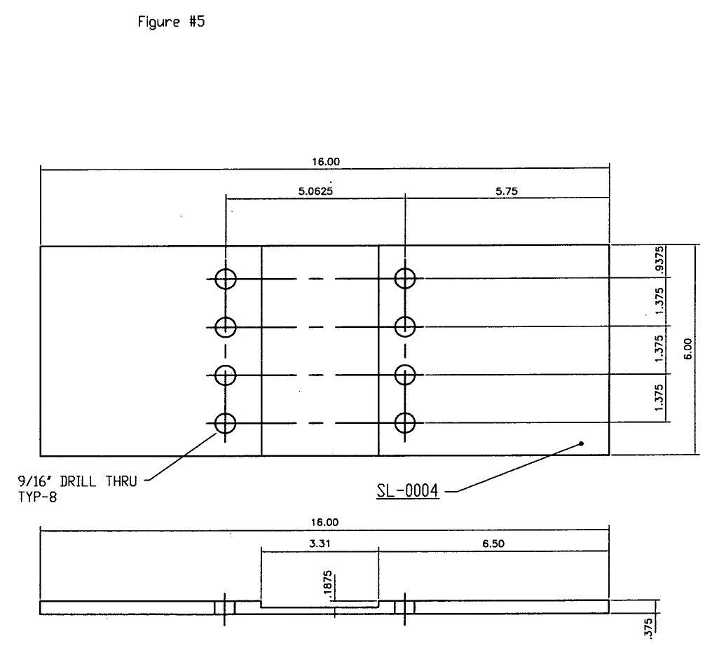

FIG. 6: Pictures of the manufactured SL0001 and SL0002 SLIKLOC permanent hasp for the vertical doors of the semi-trailer cargo or refrigerated vans or intermodal railroad container or intermodal marine container.

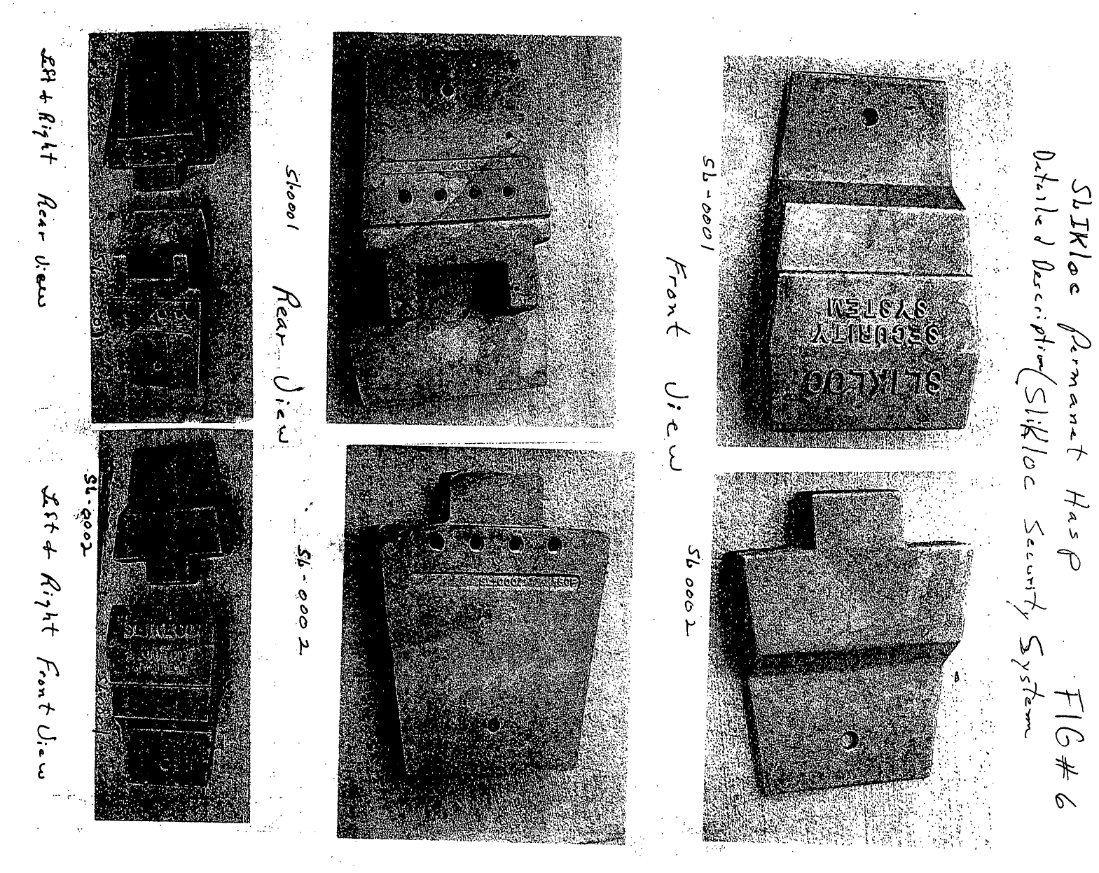

FIG. 7: Option 1 Hydraulically removed locking pin with caps and internal snap ring to lock in place to be used when either Options 2 or 3 are not used (see FIG. 9).

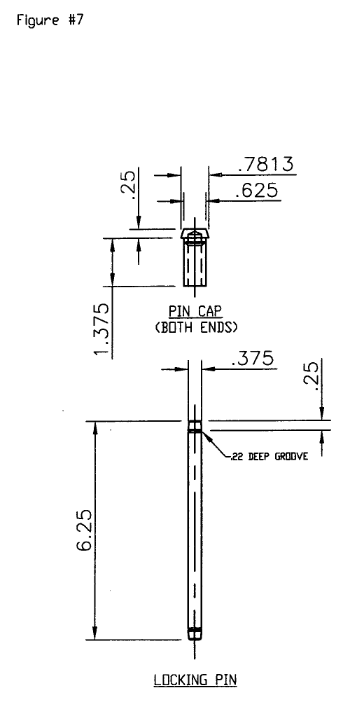

FIG. 8: SLIKLOC Hydraulic Removal Tool includes a hydraulic pneumatic and mechanical jack with a hardened pin to puncture the cap and push the cap free of the pin (see FIG. 7). The caps and head of the hydraulic jack are designed to match for removal of the locking pin. (Note that there will be different hydraulic jack heads and caps for different customers.)

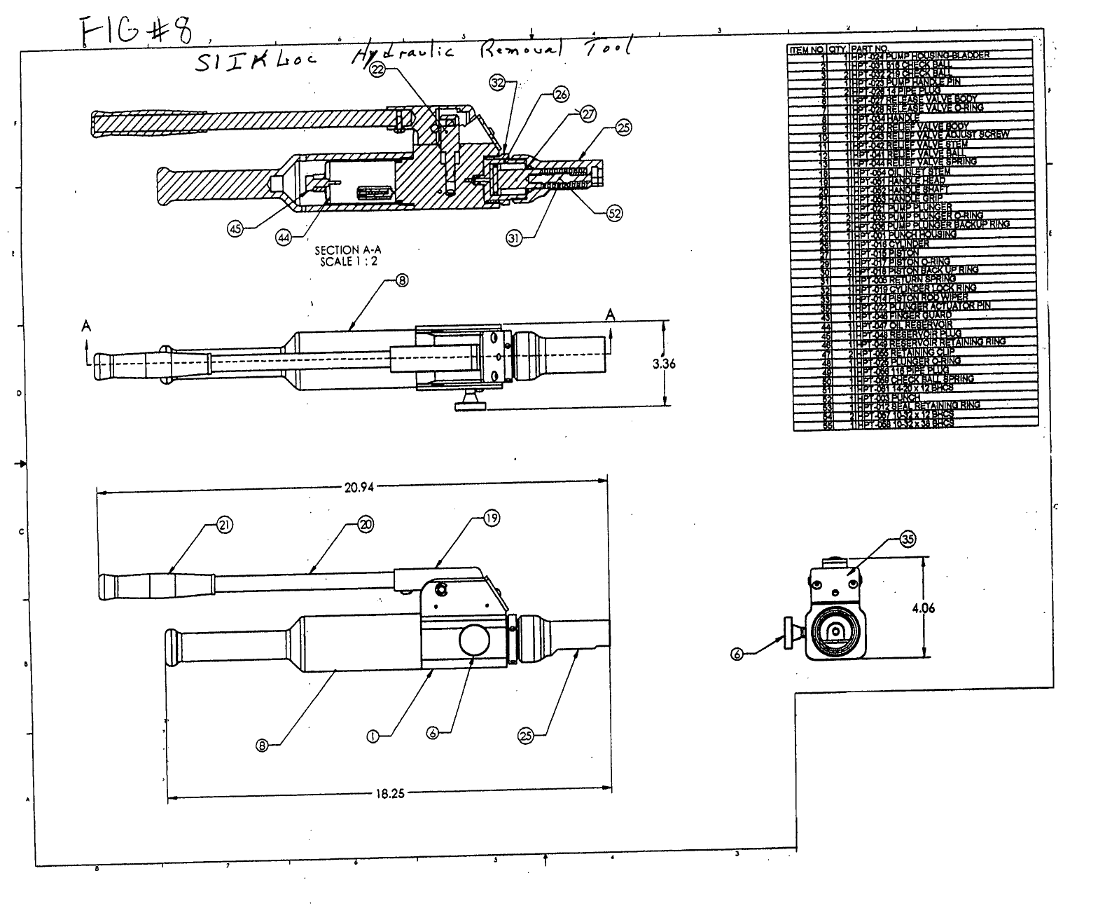

FIG. 9: When the hydraulically removed pin is not used, either Option 2 the Pagoda Key or Option 3 the Barrel Key can be installed.

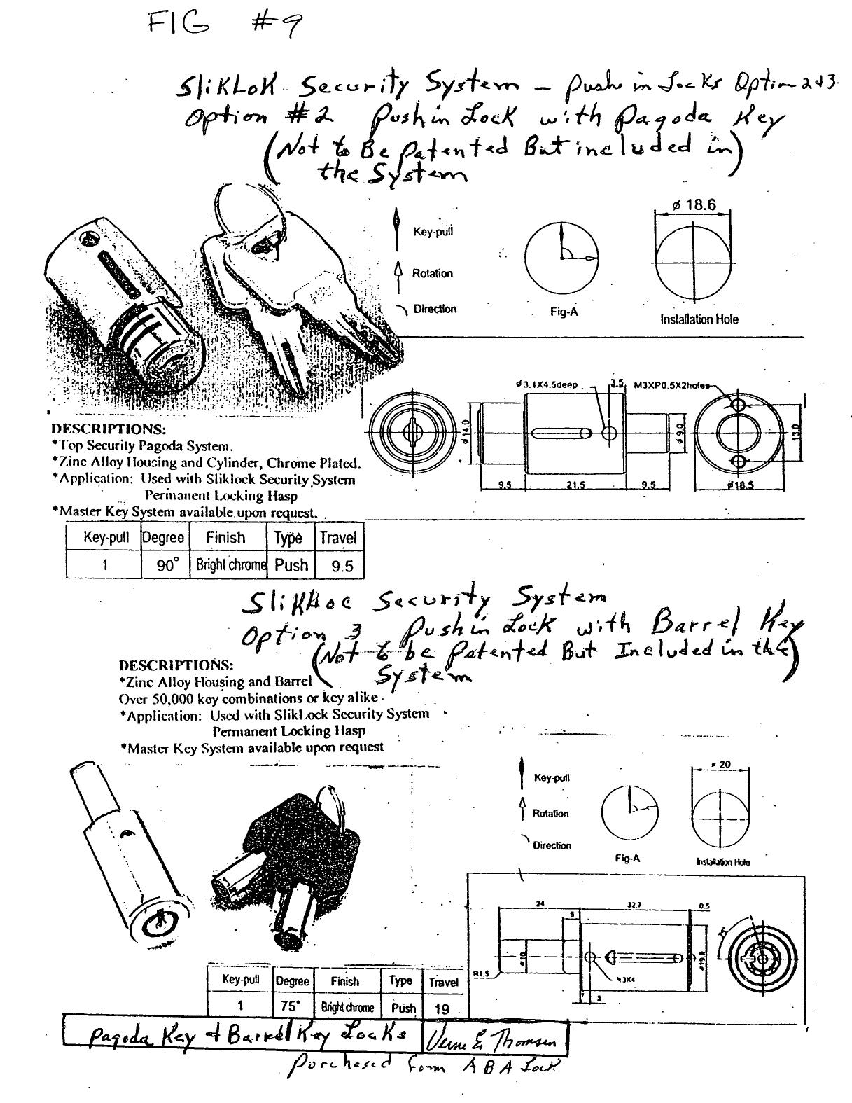

### DETAILED DESCRIPTION OF THE INVENTION

The SLIKLOC assembly SL0001 and SL0002 are first poured out of Ductile Steel or similar hardened metal at approximately Rockwell C scale 42 to 48 and tensile strength of 50,000 to 70,000 PSI. The SL0003 is mild steel with ½ inch drilled holes to match the threaded ½ inch SAE holes in the back of SL0001 and SL0002. After being poured at the foundry, they are machined according to the drawing SL0004. A protective, rust proof coating is applied. Examples of the materials used in the coating are powder coatings and zinc coatings. The installation tool is used to align SL0001 and SL0002 on the left and right rear doors respectively of the marine or railroad intermodal containers or the semi-truck cargo or refrigerated vans.

With proper placement of the SL0004 approximately in the middle of the vertical doors the ½ inch holes are drilled through the doors. The SL0001 and SL0002 are placed on the outside of the left and right side doors respectively. The SL0003 is installed on the inside of the doors and fastened with ½ inch cap screws (grade 5 or better) of proper length of two to five inches long depending on the thickness of the doors. Shims can be used to acquire the proper tightness.

After installation, they can be locked with option 1, a machined pin shank (overall length is approximately 6½ inches) and a seal pin cap secured with an internal snap ring. It is installed on the inside of the cap, which when put on, fits into the groove of the pin shank. (Note the pin shank and cap is only used once.)

To remove the pin, a hydraulic or pneumatic or mechanical jack is used to push a hardened pin through the cap pushing the pin shank down freeing the cap and pin shank from the internal snap ring.

In option 2 or 3 a push button lock can be used. The lock is held in the top and bottom by a 10/32 set screw. When the button is pushed down it locks and then can be opened with the proper keys (barrel keys or pagoda keys). The top and bottom locks can be keyed alike or differently depending on the level of security desired.

I. I claim that the SLIKLOC Security System Permanent Locking Hasp for securing the vertical doors on marine and railroad intermodal containers and semi-truck cargo and refrigerated vans provides a high degree of security from theft and can be incorporated in Homeland Security during transportation from manufacturing to the retail outlet.

II. I claim that the SLIKLOC Security System can accommodate two locking systems that can be used independently of each other.

III. I claim that one of the locking systems uses a hydraulically removed pin, which can only be removed by the hydraulic removal tool.

IV. I claim that the second locking system can use either a pagoda key or barrel key, which is secured by an alien screw when doors are open but are inaccessible when doors are closed.
